(19) United States
(12) Patent Application Publication
(10) Pub. No.: US 2008/0202780 A1
(43) Pub. Date: Aug. 28, 2008

(54) Power Drill Accessory for Loosening Soil

(76) Inventor: John P. Reiter, Richfield, MN (US)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/039,203

(22) Filed: Feb. 28, 2008

Related U.S. Application Data
(60) Provisional application No. 60/892,123, filed on Feb. 28, 2007.

(51) Int. Cl. A01B 1/22

(52) U.S. Cl. 172/381

(57) ABSTRACT

A power drill accessory includes a drive shaft (46) having an end removably interconnected to a power drill. A blade (12) for digging in soil is removably coupled by a pin (52) with the other end of the drive shaft (46). The blade (12) includes two parallel, spaced lateral sides (18) extending in a direction parallel to a blade axis (34) coaxial with a longitudinal axis of the drive shaft (46). The blade (12) further includes a top edge (20) and a bottom edge extending between the lateral sides (18). The blade (12) further includes two parallel, spaced, planar surfaces (36) each extending between the lateral sides (18) and the top edge (20) and the bottom edge. The blade axis (34) is intermediate the lateral sides (18) and intermediate the planar surfaces (36). The lateral sides (18), the top edge (20), and the bottom edge are located in a plane including the longitudinal axis and the blade axis (34).

### CROSS REFERENCE TO RELATED APPLICATION

The present application claims benefit of U.S. Application No. 60/892,088 filed on Feb. 28, 2007.

### BACKGROUND OF THE INVENTION

The present invention generally relates to a power drill accessory and, more particularly, to a power drill accessory for loosening soil.

Power drills are utilized to dig holes in soil to save labor and have accessories of various types and sizes according to different soil conditions including rough, rocky, or root-bound soil and according to different needs including digging holes, pulverizing the soil, etc. However, replacement of the power drill accessories including drive shafts and/or blades is difficult or even not allowed, leading to a burden to users for purchase of various power drill accessories.

A need exists for a power drill accessory that is easy to manufacture and that allows interchange of the drive shaft and/or blade to meet different needs.

### BRIEF SUMMARY OF THE INVENTION

The present invention solves this need and other problems in the field of soil cultivation by providing, in a preferred form, a power drill accessory including a drive shaft having a first end adapted to be removably interconnected to a power drill and a second end spaced along a longitudinal axis of the drive shaft from the first end. The second end has non-circular cross sections. A blade adapted for digging in soil is coupled with the second end of the drive shaft. The blade includes a coupling hole having non-circular cross sections corresponding to the non-circular cross sections of the second end of the drive shaft and extends along a blade axis. The second end of the drive shaft is non-rotatably but slideably received and fixed in the coupling hole along the blade axis coaxial to the longitudinal axis. The blade further includes two parallel, spaced lateral sides extending in a direction parallel to the blade axis, a top edge perpendicular to the lateral sides and to the blade axis, and a bottom edge. The top and bottom edges extend between the lateral sides. The blade further includes two parallel, spaced, planar surfaces each extending between the lateral sides and the top and bottom edges. The blade axis is intermediate the lateral sides and intermediate the planar surfaces. The lateral sides and the top and bottom edges are located in a plane including the longitudinal axis of the drive shaft and the blade axis.

In a preferred aspect, the drive shaft further includes a first aperture extending in a direction perpendicular to the longitudinal axis. The blade further includes a second aperture transverse to the blade axis and in communication with the coupling hole and aligned with the first aperture of the drive shaft. A pin is removably extended through the first and second apertures to fix the second end of the drive shaft to the blade.

In a most preferred form, the coupling hole includes a plurality of clevises formed on at least one of the planar surfaces and spaced from each other along the blade axis. Each clevis has a shape corresponding to approximately half of the non-circular cross sections of the second end of the drive shaft. Each clevis is bent from and integrally formed from a single homogenous material with the blade as a single continuous monolithic piece and has a thickness equal to the thickness between the planar surfaces. The second end of the drive shaft abuts the blade intermediate the planar surfaces below one of the clevises most distant to the top edge of the blade. The second aperture is formed in one of the clevises.

In a most preferred form, the blade includes a rectangular portion interconnected to the second end of the drive shaft. The clevises are formed on the rectangular portion. The rectangular portion includes the top edge, the lateral sides, and a bottom section. The top edge and the bottom section of the rectangular portion extend between the lateral sides. The bottom edge of the blade is a pointed portion adapted for digging in the soil. The pointed portion is coaxial with the coupling hole and includes an arcuate bottom edge and two spaced side edges. The side edges of the pointed portion are intermediate the lateral sides. In most preferred aspects, the arcuate bottom edge of the pointed portion is semicircular in shape and of a diameter equal to a spacing between the side edges of the pointed portion which are parallel to each other and parallel to the lateral sides. The pointed portion further includes a top section integrally formed as a single piece with the bottom section of the rectangular portion. The bottom section of the rectangular portion is interconnected to the side edges of the pointed portion by two arcuate interconnects having a radius at least double that of the arcuate bottom edge of the pointed portion.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a side view of a power drill accessory for loosening soil according to the preferred teachings of the present invention.

FIG. 2 shows an exploded, front view of the power drill accessory of FIG. 1.

FIG. 3 shows an exploded, top view of the power drill accessory of FIG. 1.

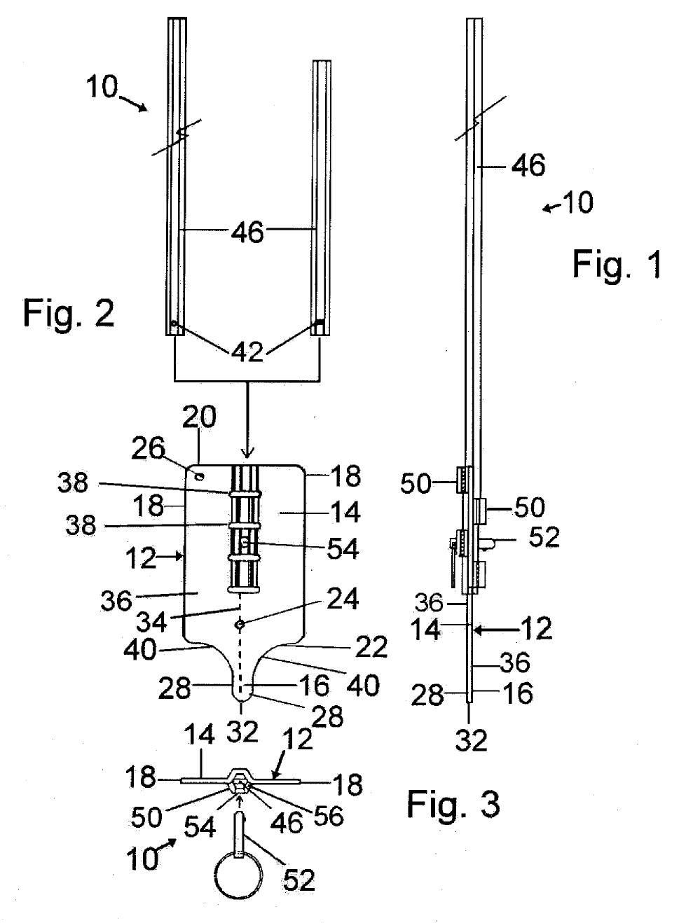

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “top”, “bottom”, “first”, “second”, “side”, “end”, “upper”, “lower”, “longitudinal”, “lateral”, “length”, “spacing”, “thickness”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

A power drill accessory for loosening soil according to the preferred teachings of the present invention is shown in the drawings and generally designated 10. Generally, accessory 10 includes an interchangeable blade 12 formed by stamping from metal sheeting most preferably formed from zinc-plated steel. Specifically, blade 12 includes a rectangular portion 14 and a pointed portion 16. Generally, rectangular portion 14 includes first and second, parallel, spaced lateral sides 18 extending along a blade axis 34, a top edge 20 perpendicular to lateral sides 18 and to blade axis 34, and a bottom section 22. Top edge 20 and bottom section 22 extend between lateral sides 18. Blade 12 further includes two parallel, spaced, planar surfaces 36 each extending between lateral sides 18 and between top edge 20 and bottom section 22. The corners between lateral sides 18 and top edge 20 and bottom section 22 are arcuate in the most preferred form. In the most preferred form, rectangular portion 14 includes a hole 24 for receipt of a peg for hanging accessory 10 when not in use, with hole 24 located intermediate lateral sides 18 and adjacent bottom section 22. Further, in the most preferred form, rectangular portion 14 includes a hole 26 located adjacent to the corner between top edge 20 and one of lateral sides 18.

In a preferred form, pointed portion 16 and bottom section 22 form a bottom edge of blade 12. Point portion 16 generally includes first and second, parallel, spaced, side edges 28, with side edges 28 being parallel to and intermediate lateral sides 18 in the most preferred form shown. Pointed portion 16 further includes an arcuate bottom edge 32 which in the preferred form is semicircular in shape and of a diameter generally equal to the spacing between side edges 28. A top section of pointed portion 16 is integrally formed as a single piece with bottom section 22 of rectangular portion 14. Bottom section 22 of rectangular portion 14 is interconnected to side edges 28 by arcuate interconnects 40 having a radius considerably larger than that of the corners between lateral sides 18 and top edge 20 and bottom section 22 and than that of arcuate bottom edge 32. In the most preferred form shown, the diameter of arcuate interconnects 40 are at least double that of arcuate bottom edge 32.

Accessory 10 further includes a drive shaft 46 interconnected to blade 12 according to the preferred teachings of the present invention and which in the most preferred form is removably interconnected to blade 12. As shown in FIG. 2, more than one shaft 46 of differing lengths can be provided. Specifically, the shorter drive shaft 46 can be utilized during use of accessory 10 for spot-planting or up-close work according to the preferred teachings of the present invention. However, the longer drive shaft 46 can be utilized during use of accessory 10 while in a comfortable standing position according to the preferred teachings of the present invention. In the preferred form shown, drive shaft 46 has non-circular cross sections along a longitudinal axis between upper and lower ends thereof and specifically in the form shown has a regular, six-sided shape. In the most preferred form, the upper end of drive shaft 46 opposite to blade 12 can have chamfered cross sections for ease of attachment to a conventional power drill.

For purposes of removable interconnection, rectangular portion 14 includes multiple clevises 50 stamped in alternate directions on planar surfaces 36 and spaced from each other along the blade axis 34. Clevises 50 define a coupling hole 56 extending along blade axis 34 intermediate lateral sides 18 and intermediate planar surfaces 36. Each clevis 50 has a shape corresponding to approximately half of the cross sectional shape of drive shaft 46 so that drive shaft 46 can be slideably received in clevises 50. In the most preferred form shown, each clevis 50 is bent from and integrally formed from a single homogenous material with blade 12 as a single continuous monolithic piece and has a thickness equal to the thickness between planar surfaces 36 of blade 12. Due to the non-circular cross sections of drive shaft 46 and clevises 50, drive shaft 46 is non-rotatably received in clevises 50, with the lower end of drive shaft 46 abutting blade 12 intermediate planar surfaces 36 below one of the clevises 50 most distant to top edge 20, and with the longitudinal axis of drive shaft 46 being coaxial to blade axis 34. It can be appreciated that lateral sides 18, bottom section 22, side edges 28, top edge 20, and arcuate bottom edge 32 are located in a plane including the longitudinal axis of drive shaft 46.

Suitable provisions are provided to prevent drive shaft 46 from sliding from clevises 50 and relative to blade 12. In the preferred form shown, a pin 52 is insertable through an aperture 54 formed in one of the clevises 50 and a corresponding aperture 42 formed in the lower end of drive shaft 46. Aperture 54 is transverse to blade axis 34 and in communication with coupling hole 56. Aperture 42 extends in a direction perpendicular to the longitudinal axis of drive shaft 46 and in alignment with aperture 54. Pin 52 can be inserted into hole 26, if desired, when not interconnecting drive shaft 46 to blade 12. However, it can be appreciated that other manners of securement between blade 12 and drive shaft 46 can be utilized according to the preferred teachings of the present invention.

In the most preferred form, blade 12 is made by stamping a single piece of metal and without any attachments such as welds, bolts, rivets, etc. Planar surfaces 36 of blade 12 are firstly stamped to form race track shaped openings 38 spaced along blade axis 34. Planar surfaces 36 of blade 12 are further stamped to form clevises 50. It can be appreciated that clevises 50 are stamped without interfering with each other due to provision of openings 38. Blade 12 thus formed is simple in structure and can be removably interconnected to drive shaft 46 in an easy way according to the preferred teachings of the present invention.

In operation and after drive shaft 46 has been interconnected to blade 12, drive shaft 46 is removably interconnected to a power drill. With arcuate bottom edge 32 resting upon the top surface of soil and with the power drill being activated, accessory 10 will rotate and quickly and effortlessly dig in the soil, breaking up rough, rocky, or root-bound soil and pulverizing the soil. It can be appreciated that accessory 10 according to the preferred teachings of the present invention quickly and easily digs consistent, uniform in size and proper depth of holes for planting seeds or plants.

Now that the basic teachings of the present invention have been explained, many extensions and variations will be obvious to one having ordinary skill in the art. For example, the size of rectangular portion 14 of blade 12 should conform to the desired size of the planting hole according to the preferred teachings of the present invention. Similarly to providing drive shafts 46 of differing lengths, blades 12 having differing sized portions 14 can be provided corresponding to desired diameters/sizes of planting holes according to the preferred teachings of the present invention. Further, hole 26 can be omitted, and pin 52 can be inserted into hole 24 when not interconnecting drive shaft 46 to blade 12. Further, pointed portion 16 and/or arcuate interconnects 40 can be of other shapes including but not limited to wedge-shaped.

Accessory 10 according to the preferred teachings of the present invention is simple in structure and can be manufactured at low costs. Furthermore, accessory 10 according to the preferred teachings of the present invention quickly and easily digs consistent, uniform in size and proper depth of holes for planting seeds or plants. Further, accessory 10 according to the preferred teachings of the present invention allows easy interchange of drive shafts 46 of differing lengths according to various soil conditions and allows easy interchange of blades 12 having differing sized portions 14 according to desired diameters/sizes of planting holes. Further, purchase of drive shafts 46 of differing lengths and blades 12 having differing sized portions 14 is more economic than purchase of power drill accessories of various types.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A power drill accessory comprising, in combination:
a drive shaft defining a longitudinal axis, with the drive shaft including a first end adapted to be removably interconnected to a power drill, with the drive shaft further including a second end spaced along the longitudinal axis from the first end, with the second end having non-circular cross sections; and
a blade adapted for digging in soil, with the blade including a coupling hole having non-circular cross sections corresponding to the non-circular cross sections of the second end of the drive shaft and extending along a blade axis, with the second end of the drive shaft being non-rotatably and slideably received in the coupling hole with the blade axis being coaxial to the longitudinal axis of the drive shaft, with the blade further including two parallel, spaced lateral sides extending in a direction parallel to the blade axis, a top edge perpendicular to the two lateral sides and to the blade axis, and a bottom edge, with the top and bottom edges extending between the two lateral sides, with the blade further including two parallel, spaced, planar surfaces each extending between the two lateral sides and the top and bottom edges, with the blade axis being intermediate the two lateral sides and intermediate the two planar surfaces, with the two lateral sides and the top and bottom edges located in a plane including the longitudinal axis of the drive shaft and the blade axis when the drive shaft is received in the coupling hole,
with the second end of the drive shaft being received and fixed in the coupling hole of the blade.

2. The power drill accessory as claimed in claim 1, with the coupling hole comprising a plurality of clevises formed on at least one of the two planar surfaces and spaced from each other along the blade axis, with each of the plurality of clevises having a shape corresponding to approximately half of the non-circular cross sections of the second end of the drive shaft, with a thickness defined between the two planar surfaces, with each of the plurality of clevises being bent from and integrally formed from a single homogenous material with the blade as a single continuous monolithic piece and having a thickness equal to the thickness between the two planar surfaces.

3. The power drill accessory as claimed in claim 2, with the second end of the drive shaft abutting the blade intermediate the two planar surfaces below one of the plurality of clevises most distant to the top edge of the blade.

4. The power drill accessory as claimed in claim 2, with the blade including a rectangular portion, with the plurality of clevises being formed on the rectangular portion, with the rectangular portion including the top edge, the two lateral sides, and a bottom section, and with the top edge and the bottom section of the rectangular portion extending between the two lateral sides, with the bottom edge of the blade being a pointed portion adapted for digging in the soil, with the pointed portion being coaxial with the coupling hole and including an arcuate bottom edge and two spaced side edges, and with the two side edges of the pointed portion being intermediate the lateral sides.

5. The power drill accessory as claimed in claim 4, with the two spaced side edges being parallel to each other and being parallel to the lateral sides.

6. The power drill accessory as claimed in claim 5, with the arcuate bottom edge of the pointed portion being semicircular in shape and of a diameter equal to a spacing between the two side edges of the pointed portion.

7. The power drill accessory as claimed in claim 6, with the pointed portion further including a top section integrally formed as a single piece with the bottom section of the rectangular portion, and with the bottom section of the rectangular portion being interconnected to the two side edges of the pointed portion by two arcuate interconnects having a radius at least double that of the arcuate bottom edge of the pointed portion.

8. The power drill accessory as claimed in claim 7, with the drive shaft further including a first aperture extending in a direction perpendicular to the longitudinal axis, with the blade further including a second aperture transverse to the blade axis and in communication with the coupling hole and aligned with the first aperture of the drive shaft, with the power drill accessory further comprising, in combination: a pin removably extended through the first and second apertures to fix the second end of the drive shaft to the blade.

9. The power drill accessory as claimed in claim 8, with the rectangular portion farther including a hole adapted for receipt of a peg for hanging the blade.

10. The power drill accessory as claimed in claim 9, with the hole being adapted for receiving the pin when not interconnecting the drive shaft to the blade.

11. The power drill accessory as claimed in claim 7, with the drive shaft having identical cross sections along the longitudinal axis between the first and second ends.

12. The power drill accessory as claimed in claim 8, with the second aperture being formed in one of the plurality of clevises.

13. The power drill accessory as claimed in claim 8, with the blade further including a hole for receiving the pin when not interconnecting the drive shaft to the blade.

14. The power drill accessory as claimed in claim 1, with the drive shaft further including a first aperture extending in a direction perpendicular to the longitudinal axis, with the blade further including a second aperture transverse to the blade axis and in communication with the coupling hole and aligned with the first aperture of the drive shaft, with the power drill accessory further comprising, in combination: a pin removably extended through the first and second apertures to fix the second end of the drive shaft to the blade.

15. The power drill accessory as claimed in claim 1, with the blade including a rectangular portion, with the rectangular portion including the top edge, the two lateral sides, and a bottom section, and with the top edge and the bottom section of the rectangular portion extending between the two lateral sides, with the bottom edge of the blade being a pointed portion adapted for digging in the soil, with the pointed portion being coaxial with the coupling hole and including an arcuate bottom edge and two spaced side edges, with the two side edges of the pointed portion being intermediate the lateral sides.

16. The power drill accessory as claimed in claim 15, with the two spaced side edges being parallel to each other and being parallel to the lateral sides.

17. The power drill accessory as claimed in claim 16, with the arcuate bottom edge of the pointed portion being semicircular in shape and of a diameter equal to a spacing between the two side edges of the pointed portion.

18. The power drill accessory as claimed in claim 17, with the pointed portion further including a top section integrally formed as a single piece with the bottom section of the rectangular portion, and with the bottom section of the rectangular portion being interconnected to the two side edges of the pointed portion by two arcuate interconnects having a radius at least double that of the arcuate bottom edge of the pointed portion.
